(19) United States
(12) Patent Application Publication
(10) Pub. No.: US 2011/0319191 A1
(43) Pub. Date: Dec. 29, 2011

(54) Golf Ball With Precompressed Medial Layer

(75) Inventor: DEREK A. FITCHETT, PORTLAND, OR (US)

(73) Assignee: NIKE, INC., BEAVERTON, OR (US)

(21) Appl. No.: 12/822,449

(22) Filed: Jun. 24, 2010

(51) Int. Cl. A63B 37/06; B29C 65/00

(52) U.S. Cl. 473/370; 264/250

(57) ABSTRACT

A golf ball is made from a plurality of layers. A core is formed of a soft material. A medial layer surrounds the core and is formed of a precompressed rubber. A cover surrounds the medial layer. A compression layer may be used to precompress the medial layer.

### FIELD

The present disclosure relates generally to a golf ball with a pre-compressed medial layer. Specifically, the present disclosure relates to a golf ball having a soft core layer surrounded by a precompressed medial layer.

### BACKGROUND

Golf balls are conventionally made from various types of materials. The material selected depends on the play conditions desired for the ball. In some instances, a designer may select a harder core material and in other instances the designer may select a softer core material. The core material selected affects how the ball performs and how a golfer perceives the feel of the ball.

Conventionally, balls are covered by a urethane cover with various conventional dimple patterns. It is desirable that the ball have a certain degree of compression and durability. Balls that have compatible layers will have a relatively longer life expectancy than balls that are made of layers that are incompatible. For example, if a ball is formed with too hard an outer layer and too soft a core layer, the outer layer will crack relatively early in the life of the golf ball and will create dissatisfaction on the part of golfers using the ball.

However, golfers also desire balls that have a lower compression. A lower compression golf ball allows a golfer to have a greater degree of control and a higher margin for error on golf shots, particularly when club head speed is low. A lower club head speed is common when a golfer is less experienced.

However, the lower compression of a golf ball is often created by using a softer core material. The use of this core material may create, as noted, the increased possibility of cracking and diminished life of the golf ball.

Therefore, there exists a need in the art for a golf ball created to have a soft core but with an appropriate life expectancy.

### SUMMARY

In one aspect, a golf ball includes a core, a medial layer, and a cover. The core may be made from a highly neutralized polymer. The medial layer may be formed from a precompressed rubber and may be positioned radially outwardly of the core. The cover may be positioned radially outwardly of the medial layer. The medial layer may be formed from a first medial layer portion and a second medial layer portion.

In another aspect, a method of making a golf ball includes the steps of molding a core, molding a medial layer, and molding a cover. The method may also include precompressing the medial layer and placing it in surrounding position over the core. The method may also include placing the cover in surrounding position over the medial layer. The step of molding a medial layer may include forming a first medial layer portion and a second medial layer portion.

In another aspect, a golf ball may include four layers. The ball may include a core. A medial layer may surround the core. A compression layer may surround and precompress the medial layer. A cover may surround the compression layer.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a side view of an embodiment of a golf ball;

FIG. 2 is a cross-sectional view of the golf ball of FIG. 1 taken along line 2-2;

FIG. 3 is a cross-sectional view of an embodiment of a mold used to form a core of a golf ball;

FIG. 4 is a cross-sectional view of an embodiment of a mold used to form a medial layer of a golf ball;

FIG. 5 is a cross-sectional view of an embodiment of a mold used to form a cover of a golf ball;

FIG. 6 is a cross-sectional view of an embodiment of a mold used to form a medial layer of a golf ball;

FIG. 7 is a cross-sectional view of an embodiment of a mold used to position a medial layer over a core of a golf ball;

FIG. 8 is a cross-sectional view of an embodiment of a mold used to form a cover of a golf ball;

FIG. 9 is a cross-sectional view of an embodiment of a mold used to position a cover over a medial layer of a golf ball; and

FIG. 10 is a side view showing a compression layer used in connection with a core and medial layer of a golf ball.

### DETAILED DESCRIPTION

Golf balls traditionally have multiple layers. While it is possible to use a golf ball that is made of one solid material, such a ball is unusual, as golf balls having multiple layers are typically designed to allow a golfer to strike the ball such that it would fly longer or with greater control than a ball that is made of one solid material. Each layer of a golf ball is selected to provide one or more key characteristics for the golfer. The present embodiments also include multiple layers.

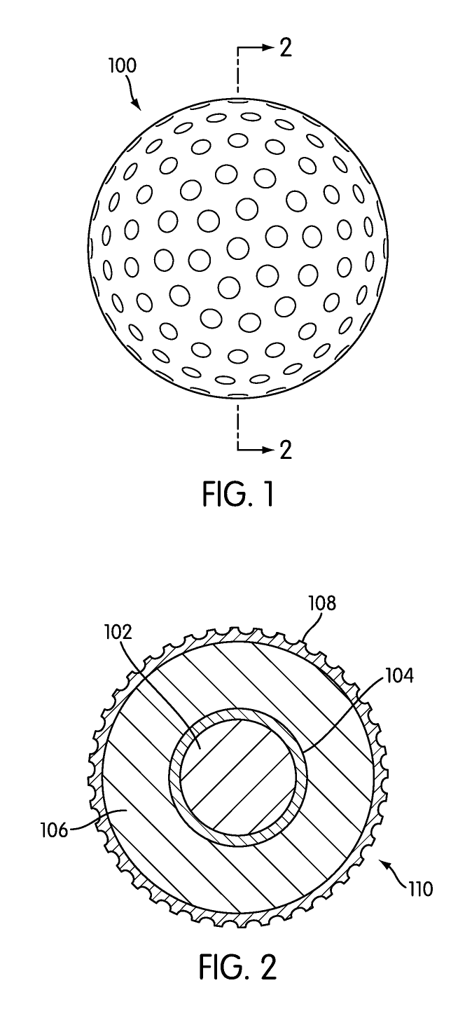

FIGS. 1 and 2 show the general construction of a golf ball 100. FIG. 1 shows the appearance of the ball to a golfer (not shown). FIG. 2 is a cross-section of the ball 100 taken along line 2-2. Ball 100 is desirably generally radially symmetrical, and accordingly, any section of ball 100 is likely to yield a similar sectional view. Ball 100 may include a plurality of layers. Ball 100 may include a core 102, mantle layer 104, medial layer 106, and cover 108.

Core 102 is preferably a generally spherical core that is made from any desirable material. In some embodiments, the material may desirably be a highly neutralized polymer, such as HFP, available from DuPont. In other embodiments, it may be desirable to use an alternative material that is relatively soft.

Mantle layer 104 may be included in some embodiments. Mantle layer 104 may take the form of a relatively hard material that is radially outward of core 102.

Medial layer 106 is radially outward of core 102. Medial layer 106 may be made of rubber in some embodiments. In some embodiments, medial layer 106 may be made of a harder material than core 102. In some embodiments, medial layer 106 may be compressed before or while being assembled as part of ball 100. In some embodiments, medial layer 106 may be a precompressed rubber.

Cover 108 is shown in this and may of the other FIGS. in simplified form. In a commercial version, cover 108, and in particular, outer surface 110 of cover 108, is configured to be struck by a golf club. Accordingly, cover 108 may include various dimples, frets or lands, projections, printing, or any other features that a designer thinks would be desirable in affecting the flight path of ball 100. Cover 108 may be designed to be scuff resistant. In some embodiments, cover 108 may be made of an urethane, such as SURLYN.

In some embodiments, ball 100 includes only core 102 formed of HNP, a harder precompressed rubber medial layer 106, and a still harder cover 108 made of urethane. When a precompressed rubber is used to form medial layer 106, it may improve the durability of ball 100. When core 102 is made from HNP and medial layer 106 is not precompressed, core 102 tends to compress more greatly after impact from a club than medial layer 106 does. This creates an imbalance of pressure and, in some instances, may create a slight vacuum within ball 100. This imbalance may create a cracking of medial layer 106, particularly in the area where core 102 and medial layer 106 separate and may cause cover 108 to crack. This cracking reduces the life expectancy of ball 100.

If, instead, medial layer 106 is precompressed, when core 102 compresses, medial layer 106 may be able to expand slightly from its precompressed state into the region from which core 102 would otherwise compress away from medial layer 106. This expansion and compression allows for a greater durability of ball 100. Accordingly, the materials used in this manner may be useful in increasing the life of ball 100.

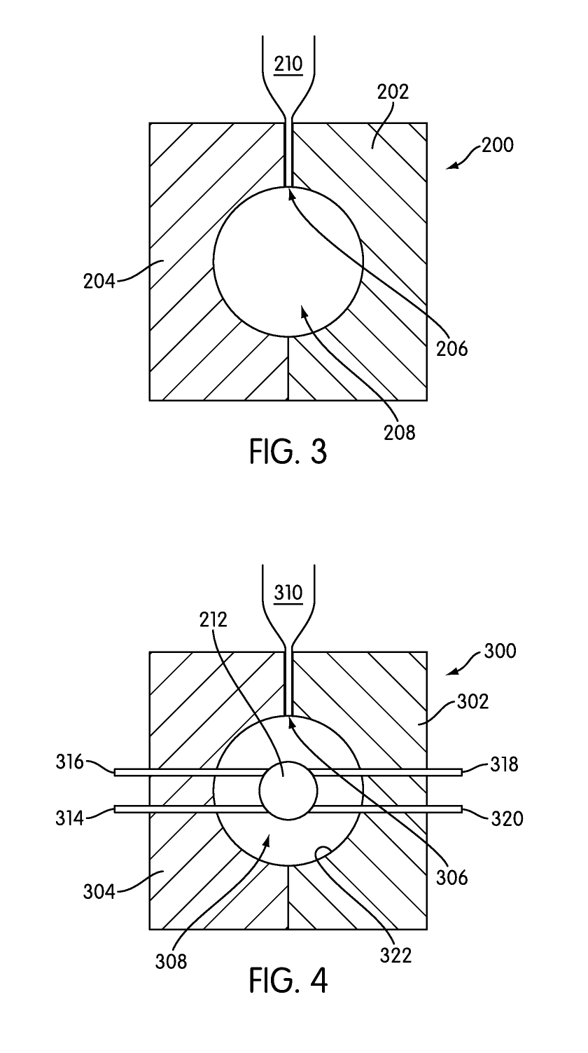

There are at least two methods available alone or in combination to mold a ball 100 that has the described properties. These methods are shown in FIGS. 3-9.

As shown in FIG. 3, a core may be formed, for example, using a standard compression or injection first mold 200. First mold 200 may include first mold first portion 202 and first mold second portion 204. A first injection port 206 may be present, for example, at the top of first mold cavity 208. First injection port 206 may be in fluid communication with first reservoir 210 that contains the material from which the core may be formed. In many embodiments, the material may be HNP. The material is introduced into first mold cavity 208 from first reservoir 210 via first injection port 206.

First mold 200 may be heated or cold, depending on what material is used and what its properties are. For example, if the material used is a thermosetting material, first mold 200 may be heated so that the material is heated to its setting temperature. If, instead, the material is thermoplastic, first mold 200 may only be heated to promote the even flow of material into first mold cavity 208 to ensure that first mold cavity 208 is evenly filled. Other materials may allow first mold 200 to remain at about room temperature during molding. After the material is treated in an appropriate manner to allow the material to be appropriately molded, first mold 200 may be cooled or allowed to cool, if necessary. After an appropriate time has passed, such as the time it takes for first mold 200 to reach room temperature or the material is allowed to cure for the appropriate amount of time, the core formed by the molding process can be removed from first mold 200. FIG. 3 shows one example of an appropriate structure for molding the core. However, this precise structure need not be used. Instead, another structure appropriate for molding the core could be used that is appropriate for the material desired for the core.

Once core 212 has been molded, core 212 may be placed in second mold 300, as shown in FIG. 4. FIG. 4 shows second mold 300 that may be used to overmold a medial layer in situ over core 212. Second mold 300 may include second mold first portion 302 and second mold second portion 304. A second injection port 306 may be present, for example, at the top of second mold cavity 308. Second injection port 306 may be in fluid communication with second reservoir 310 that contains the material from which the medial layer may be formed. The material is introduced into second mold cavity 308 from second reservoir 310 via second injection port 306. In some embodiments, the material injected into second mold cavity 308 may be rubber.

As shown in FIG. 4, one option for properly positioning core 212 in second mold cavity 308 is to support core 212 with a plurality of pins. FIG. 4 shows the use of first pin 314, second pin 316, third pin 318, and fourth pin 320. First pin 314, second pin 316, third pin 318, and fourth pin 320 are designed to be retractable within second mold cavity 308. As the second material is injected into second mold cavity 308, it fills mold cavity 308. As it begins to harden, it becomes capable of supporting core 212 within second mold cavity 308. As the material begins to harden and support core 212, first pin 314 and fourth pin 320 can be retracted. As the material begins to further fill second mold cavity 308, second pin 316 and third pin 318 can be retracted. In some embodiments, all the pins may be retracted simultaneously. This retraction after the partial hardening of the material allows core 212 to remain centered within second mold cavity 308 and for the material to evenly fill second mold cavity 308.

While four pins 314, 316, 318, 320 are shown, and while they are shown protruding only from the sides of second mold cavity 308, these features should not be seen as being limiting. In some embodiments, it may be desirable to place more or fewer pins in second mold cavity 308. In other embodiments, it may be desirable to space the pins more evenly throughout second mold cavity 308. Finally, it may be desirable to include pins on the top or bottom sides of second mold cavity 308. A person having ordinary skill in the art will be able to modify the mold design to provide an appropriate molding environment based on the materials selected and the design characteristics desired.

Second mold 300 may also be heated or at room temperature, depending on the material to be injected to form the medial layer. If second mold 300 is heated, second mold 300 may be allowed to cool. After an appropriate time has passed, such as the time it takes for second mold 300 to reach room temperature or after core 212 and the medial layer have been allowed to cure for an appropriate amount of time, core 212 and the medial layer may be removed from second mold 300.

If desired, inner walls 322 of second mold cavity 308 may be designed to provide an initial precompression of the material that forms medial layer. Inner walls 322 may, for example, be designed to be movable to further press in on the material after it reaches a cured or partially cured state to precompress the material.

While a particular structure is shown in FIG. 4 for molding a medial layer that is positioned radially outwardly of a core, other structures may be used in place of that shown in FIG. 4. Other structures may be used for either in situ overmolding or other types of molding. A person having ordinary skill in the art is able to select an appropriate structure based on the characteristics desired for the medial layer and the material desired to be used.

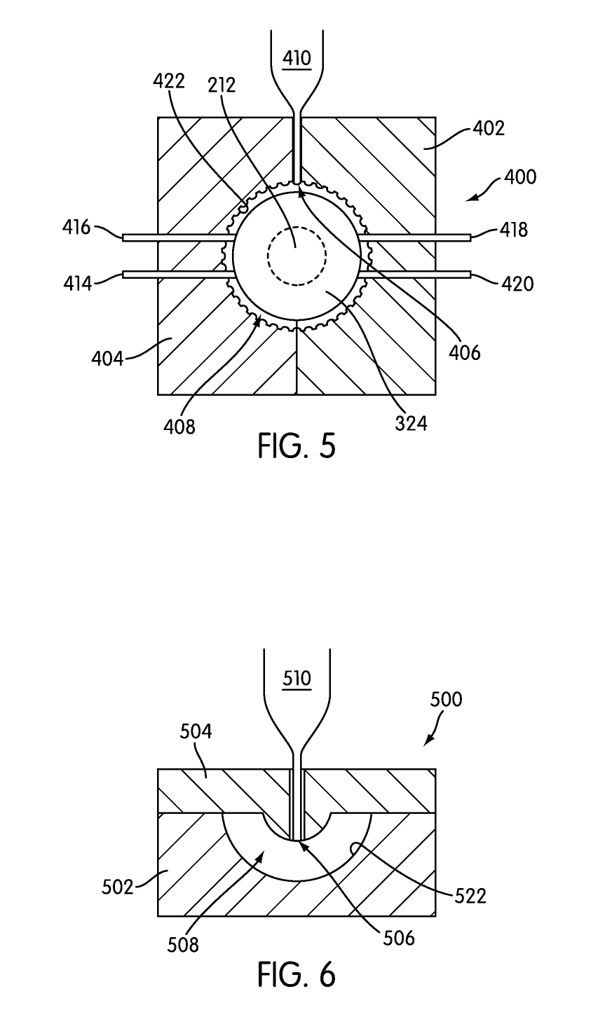

After medial layer 324 has been completely formed, medial layer 324 and core 212 within may be placed in third mold 400 as shown in FIG. 5. FIG. 5 shows third mold 400 that may be used to overmold a cover in situ over core 212 and medial layer 324. Third mold 400 may include third mold first portion 402 and third mold second portion 404. A third injection port 406 may be present, for example, at the top of third mold cavity 408. Third injection port 406 may be in fluid communication with third reservoir 410 that contains the material from which the cover may be formed. In some embodiments, the material may be SURLYN. The material is introduced into third mold cavity 408 from third reservoir 410 via third injection port 406.

As shown in FIG. 5, one option for properly positioning medial layer 324 in third mold cavity 408 is to support medial layer 324 with a plurality of pins. FIG. 5 shows the use of fifth pin 414, sixth pin 416, seventh pin 418, and eighth pin 420. Fifth pin 414, sixth pin 416, seventh pin 418, and eighth pin 420 are designed to be retractable within third mold cavity 408. As the third material is injected into third mold cavity 408, it fills third mold cavity 408. As it begins to harden, it becomes capable of supporting medial layer 324 within third mold cavity 408. As the material begins to harden and support medial layer 324, fifth pin 414 and eighth pin 420 can be retracted. As the material begins to further fill third mold cavity 408, sixth pin 416 and seventh pin 418 can be retracted. In some embodiments, all the pins may be retracted simultaneously. This retraction after the partial hardening of the material allows medial layer 324 to remain centered within third mold cavity 408 and for the material to evenly fill third mold cavity 408.

While four pins 414, 416, 418, 420 are shown, and while they are shown protruding only from the sides of third mold cavity 408, these features should not be seen as being limiting. In some embodiments, it may be desirable to place more or fewer pins in third mold cavity 408. In other embodiments, it may be desirable to space the pins more evenly throughout third mold cavity 408. Finally, it may be desirable to include pins on the top or bottom sides of third mold cavity 408. A person having ordinary skill in the art will be able to modify the mold design to provide an appropriate molding environment based on the materials selected and the design characteristics desired.

In this step, pins 414, 416, 418, 420 may also be used to perform another function. Pins 414, 416, 418, 420 may be spaced and designed in such a manner to place additional pressure on medial layer 324 while third mold cavity 408 is being filled with the cover material. This pressure may be sufficient to hold medial layer 324 in a precompressed condition while the cover is being overmolded. Alternatively, the material forming the cover may be injected at a pressure that causes additional compression of medial layer 324. Other methods for precompressing medial layer 324 may be available to persons having ordinary skill in the art and may alternatively be used in place of the structures and methods disclosed.

Third mold 400 may also be heated or at room temperature, depending on the material to be injected to form the cover. If third mold 400 is heated, third mold 400 may be allowed to cool. After an appropriate time has passed, such as the time it takes for third mold 400 to reach room temperature or after the cover, medial layer 324, and core 212 have been allowed to cure for an appropriate amount of time, the formed ball may be removed from third mold 400.

As shown in FIG. 5, the configuration of the inner walls 422 of third mold 400 may be designed to mold the outer surface of the ball. Accordingly, the inner walls 422 may be patterned to allow for dimples and lands and other desirable markings to be molded into the cover of the ball. The precise configuration of the outer ball surface will depend on the desired ball characteristics. A person having ordinary skill in the art will be able to easily design the inner walls 422 with desired characteristics in accordance with the ball's desired characteristics without undue experimentation. The pattern of dimples on the outside of the ball may be designed independently of the characteristics for the inner layers of the ball.

FIGS. 6-9 show an alternative method for making several of the layers of the ball. The method shown in FIGS. 6-9 does not include a step of molding the core. The core can be molded by the method shown in FIG. 3 or another equivalent method. Such a core can be united with the rest of the ball via the method shown in FIGS. 6-9.

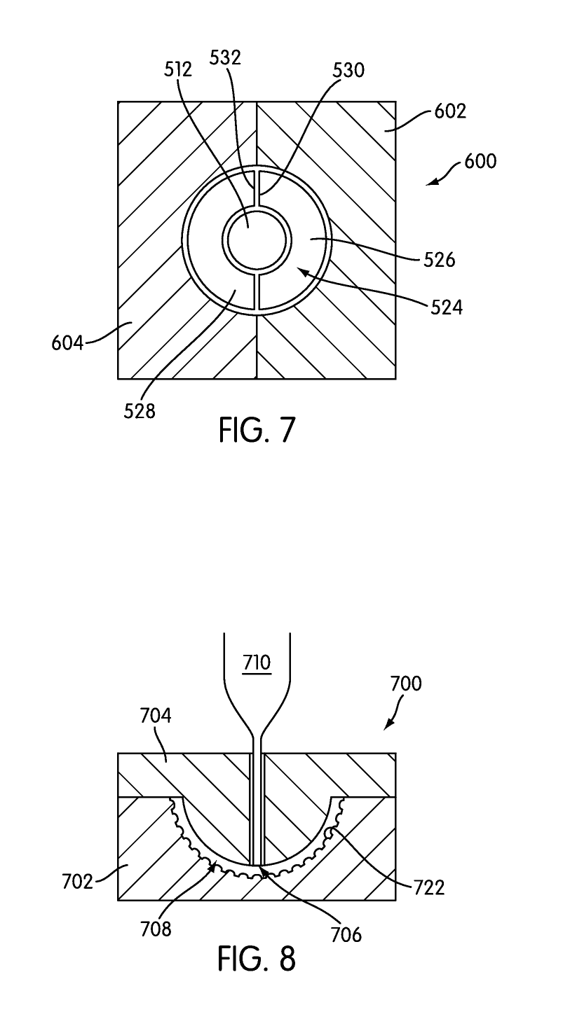

FIGS. 6 and 7 show a method of making the medial layer and mating it with the core. FIG. 6 shows a first mold 500 having a first mold first portion 502 and a first mold second portion 504. A first injection port 506 may be present, for example, at the top of first mold cavity 508. First injection port 506 may be in fluid communication with first reservoir 510 that contains the material from which the medial layer may be formed. The material is introduced into first mold cavity 508 from first reservoir 510 via first injection port 506. In some embodiments, the material injected into first mold cavity 508 may be rubber.

In some embodiments, it may be useful to precompress the medial layer while it is being molded. Inner walls 522 of first mold cavity 508 may be designed to be movable to compress the material in first mold cavity 508 while it is curing or after it is cured. This precompression may be desirable in some embodiments before the medial layer is mated with the core.

In some embodiments, such as the embodiment shown in FIG. 6, first mold cavity 508 may be designed to mold only a part or portion of the medial layer. In the FIG. 6 embodiment, about half the medial layer is shown being formed. When such a structure is used, two medial layer portions are desirably molded in this or another manner to be used in connection with the core.

First mold 500 may be heated or cold, depending on what material is used and what its properties are. For example, if the material used is a thermosetting material, first mold 500 may be heated so that the material is heated to its setting temperature. If, instead, the material is thermoplastic, first mold 500 may only be heated to promote the even flow of material into first mold cavity 508 to ensure that first mold cavity 508 is evenly filled. Other materials may allow first mold 500 to remain at about room temperature during molding. After the material is treated in an appropriate manner to allow the material to be appropriately molded, first mold 500 may be cooled or allowed to cool, if necessary. After an appropriate time has passed, such as the time it takes for first mold 500 to reach room temperature or for the material to be allowed to cure for the appropriate amount of time, the medial layer portion formed by the molding process can be removed from first mold 500. FIG. 6 shows one example of an appropriate structure for molding the medial layer portion. However, this precise structure need not be used. Instead, another structure appropriate for molding the medial layer portion could be used that is appropriate for the material desired for the medial layer portion.

FIG. 7 shows the use of core 512 and medial layer 524. Medial layer 524 includes first medial layer portion 526 and second medial layer portion 528. As shown in FIG. 7, core 512 is placed in second mold 600 that includes second mold first portion 602 and second mold second portion 604. Second mold 600 may join first medial layer portion 526 and second medial layer portion 528 in several ways. Any joining structure or method would be suitable in place of second mold 600.

Adhesive may, for example, be applied to first mating face 530 of first medial layer portion 526, second mating face 532 of second medial layer portion 528, or both. Second mold 600 may be used to place first mating face 530 and second mating face 532 in abutting relationship to allow first medial layer portion 526 and second medial layer portion 528 to become joined together via the adhesive. Second mold 600 may be heated, if necessary, to activate or cure the adhesive.

Alternatively, first medial layer portion 526 and second medial layer portion 528 may be made of a material or materials that will fuse or otherwise become attached to one another upon application of pressure or heat. In such an instance, mold 600 may be designed to apply the designated degree of pressure or heat to first medial layer portion 526 and second medial layer portion 528. It may be necessary only to apply heat or pressure in the area where first face 530 and second face 532 abut, and accordingly, it may only be desirable to incorporate a heating or pressure element locally within mold 600 adjacent the region where first face 530 and second face 532 meet.

As a further alternative, if first medial layer portion 526 and second medial layer portion 528 are made of material that will fuse or otherwise attach to one another, first face 530 and second face 532 may be treated before they are placed in an abutting relationship. For example, first face 530 and second face 532 may be exposed to a heat treatment immediately before being placed in mold 600.

Core 512 and medial layer 524 are desirably held in mold 600 until an adequate cure time has passed or until the layers have cooled enough for further handling to appropriately take place. Mold 600 may also be designed to precompress medial layer 524.

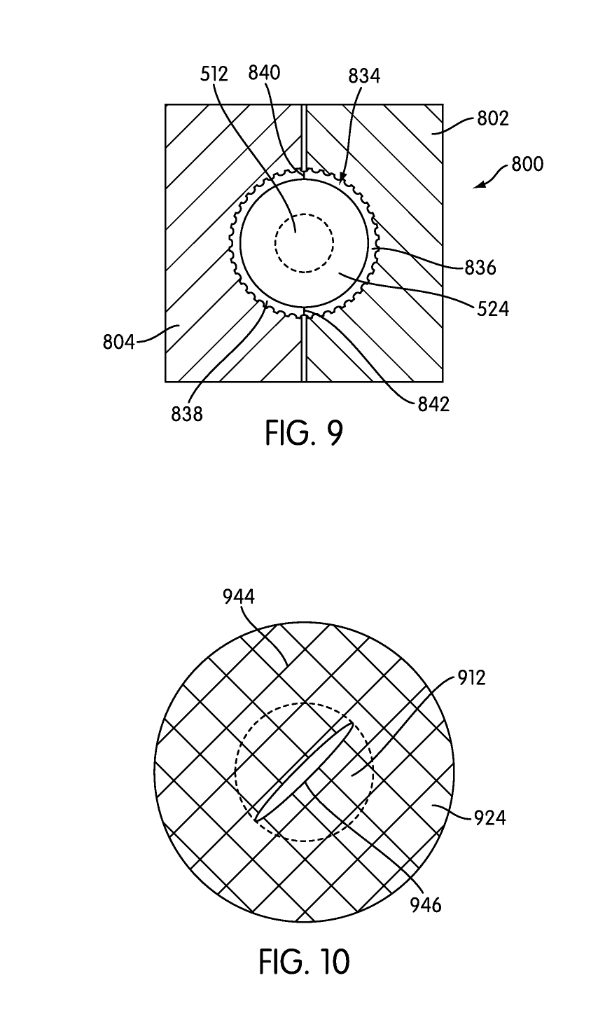

FIGS. 8 and 9 show a method of making the cover and mating it with the core and medial layer. FIG. 8 shows a third mold 700 having a third mold first portion 702 and a third mold second portion 704. A second injection port 706 may be present, for example, at the top of third mold cavity 708. Second injection port 706 may be in fluid communication with second reservoir 710 that contains the material from which the cover may be formed. The material is introduced into third mold cavity 708 from second reservoir 710 via second injection port 706. In some embodiments, the material injected into third mold cavity 708 may be polyurethane.

The cover molded in third mold 700 desirably has an outer surface that includes dimples and lands and possibly other markings. Accordingly, it may be desirable in some embodiments for the inner walls 722 of third mold 700 to include the desired configuration of the ball's outer surface.

In some embodiments, such as the embodiment shown in FIG. 8, third mold cavity 708 may be designed to mold only a part of the cover. In the FIG. 8 embodiment, about half the cover is shown being formed. When such a structure is used, two cover pieces or parts are desirably molded in this or another manner to be used in connection with the core and medial layer.

Third mold 700 may be heated or cold, depending on what material is used and what its properties are. For example, if the material used is a thermosetting material, third mold 700 may be heated so that the material is heated to its setting temperature. If, instead, the material is thermoplastic, third mold 700 may only be heated to promote the even flow of material into third mold cavity 708 to ensure that third mold cavity 708 is evenly filled. Other materials may allow third mold 700 to remain at about room temperature during molding. After the material is treated in an appropriate manner to allow the material to be appropriately molded, third mold 700 may be cooled or allowed to cool, if necessary. After an appropriate time has passed, such as the time it takes for third mold 700 to reach room temperature or for the material to be allowed to cure for the appropriate amount of time, the cover piece formed by the molding process can be removed from third mold 700. FIG. 8 shows one example of an appropriate structure for molding the cover piece. However, this precise structure need not be used. Instead, another structure appropriate for molding the cover piece could be used that is appropriate for the material desired for the cover piece.

FIG. 9 shows the use of core 512, medial layer 524, and cover 834. Cover 834 includes first cover piece 836 and second cover piece 838. As shown in FIG. 9, core 512 and the surrounding medial layer 524 are placed in fourth mold 800 that includes fourth mold first portion 802 and fourth mold second portion 804. Fourth mold 800 may join first cover piece 836 and second cover piece 838 in several ways. Any joining structure or method would be suitable in place of fourth mold 800.

Adhesive may, for example, be applied to first mating face 840 of first cover piece 836, second mating face 842 of second cover piece 838, or both. Fourth mold 800 may be used to place first mating face 840 and second mating face 842 in abutting relationship to allow first cover piece 836 and second cover piece 838 to become joined together via the adhesive. Fourth mold 800 may be heated, if necessary, to activate or cure the adhesive.

Alternatively, first cover piece 836 and second cover piece 838 may be made of a material or materials that will fuse or otherwise attach to one another upon application of pressure or heat. In such an instance, fourth mold 800 may be designed to apply the designated degree of pressure or heat to first cover piece 836 and second cover piece 838. It may be necessary only to apply heat or pressure in the area where first face 840 and second face 842 abut, and accordingly, it may only be desirable to incorporate a heating or pressure element locally within fourth mold 800 in a region where first face 840 and second face 842 meet.

As a further alternative, if first cover piece 836 and second cover piece 838 are made of material that will fuse or otherwise attach to one another, first face 840 and second face 842 may be treated before they are placed in an abutting relationship. For example, first face 840 and second face 842 may be exposed to a heat treatment immediately before being placed in fourth mold 800.

Core 512, medial layer 524, and cover 834 are desirably held in fourth mold 800 until an adequate cure time has passed or until the layers have cooled enough for further handling to appropriately take place.

The drawings illustrate layers having a variety of thicknesses and other thicknesses have been mentioned in connection with one or more embodiments. These thicknesses should not be considered to be the only possible thicknesses for the layers. The desirable thicknesses for the various layers depends on the materials a designer wishes to use and the protection or reactivity the designer wishes to provide by the various layers. A person having ordinary skill in the art can modify the present embodiments to provide for a ball having layers of appropriate thicknesses.

The materials listed in this disclosure are examples of desirable materials. In some embodiments, it may be desirable to select materials of gradually increasing hardness from the center of the ball to the outside of the ball. For example, in some embodiments, it may be desirable to use a first material for the core, a second material for the medial layer, and a third material for the cover. The first material may be softer than the second material and the second material may be harder than the third material. In embodiments where a mantle layer made of a fourth material is included between the core and the medial layer, the fourth material may be harder than the first material and softer than the second material. Alternatively, in other embodiments, the fourth material may be harder than both the first material and the second material.

In some embodiments, it may be desirable to include a compression material as an additional layer to assist in precompressing the medial layer. An example of such a structure is shown in FIG. 10. FIG. 10 shows core 912 surrounded by medial layer 924. Surrounding medial layer 924 is compression layer 944. Compression layer 944 is shown as a webbing, but compression layer 944 could form a solid surface instead of a webbing, and may instead have a denser or looser weave than that shown in FIG. 10. Compression layer 944 may be formed of an elastic or other resilient material. In order to precompress medial layer 924, compression layer 944 may be designed to have a tensile strength adequate to compress medial layer 924 without breakage, while still having adequate resilience to be stretched to fit around medial layer 944. Compression layer may have an opening 946 that is shaped and sized such that core 912 and surrounding medial layer 924 can fit into compression layer 944 after molding. Opening 946 may be formed of a more resilient material than the remainder of compression layer 944 if necessary to allow medial layer to be inserted into compression layer 944. After medial layer 924 has been inserted into compression layer 944, core 912, medial layer 924 and compression layer 944 may be further surrounded by a cover using any of the methods and systems described above.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A golf ball, comprising:
a core formed of a highly neutralized polymer;
a medial layer positioned radially outwardly of the core formed of a precompressed rubber; and
a cover positioned radially outwardly of the medial layer.

2. The golf ball according to claim 1, wherein the medial layer is overmolded in situ over the core.

3. The golf ball according to claim 2, wherein the cover is overmolded in situ over the medial layer.

4. The golf ball according to claim 1, wherein the medial layer comprises a first medial layer portion and a second medial layer portion molded separately from one another and the core and wherein the medial layer portions are placed around the core.

5. The golf ball according to claim 4, wherein the cover is overmolded in situ over the medial layer.

6. The golf ball according to claim 4, wherein the cover is a first cover piece and a second cover piece.

7. The golf ball according to claim 6, wherein the first cover piece and the second cover piece are fused together surrounding the medial layer.

8. The golf ball according to claim 1, further comprising a mantle layer.

9. A method of making a golf ball, comprising:
molding a core;
molding a medial layer;
precompressing the medial layer;
placing the medial layer in surrounding position over the core;
molding a cover; and
placing the cover in surrounding position over the medial layer.

10. The method of making a golf ball according to claim 9, wherein the step of molding a medial layer comprises forming a first medial layer portion and forming a second medial layer portion.

11. The method of making a golf ball according to claim 9, wherein the steps of molding a medial layer and placing the medial layer in surrounding position to the core comprises overmolding the medial layer over the core.

12. The method of making a golf ball according to claim 9, wherein the step of molding a cover comprises forming a first cover piece and a second cover piece.

13. The method of making a golf ball according to claim 9, wherein the step of molding a cover and placing the cover in surrounding position to the medial layer comprises overmolding the cover over the medial layer.

14. The method of making a golf ball according to claim 9, wherein the step of molding a core comprises molding a core of a first material and the step of molding a medial layer comprises molding a medial layer of a second material harder than the first material.

15. The method of making a golf ball according to claim 9, wherein the step of precompressing the medial layer comprises placing a compression layer over the medial layer.

16. A golf ball, comprising:
a core;
a medial layer surrounding the core;
a compression layer surrounding and precompressing the medial layer; and
a cover surrounding the compression layer.

17. The golf ball according to claim 16, wherein the core is made of a highly neutralized polymer.

18. The golf ball according to claim 16, wherein the medial layer is made of a rubber.

19. The golf ball according to claim 18, wherein the compression layer is made of a material capable of compressing the rubber.

20. The golf ball according to claim 16, wherein the cover is made of a polyurethane.
